(19) United States
(12) Patent Application Publication
(10) Pub. No.: US 2004/0217179 A1
(43) Pub. Date: Nov. 4, 2004

(54) Car regulating thermostat

(76) Inventor: Michael Darnell Garner, Huntsville, AL (US)

Correspondence Address: Michael D. Garner Jr., 119 Crab Apple Road, Huntsville, AL, 35811, US

(21) Appl. No.: 10/714,241

(22) Filed: Nov. 13, 2003

Related U.S. Application Data
(60) Provisional application No. 60/416,458, filed on Dec. 2, 2002.

(51) Int. Cl. G05D 23/00

(52) U.S. Cl. 236/1 C; 236/91 R

(57) ABSTRACT

The Car Regulating Thermostat is the answer to freezing cold work mornings and scorching hot afternoons. This system is very much like the thermostat found in most modern homes where you set the temperature settings and the system will automatically keep the house at that temperature. The same goes for the automobile with this system which has its own computer for settings and motor for utilization without the car's engine running. This system also has it's own unique power source called The Trinity System for an efficient and reliable power source. Since this system uses it's own power source there is no gas consumption and no pollution released into the atmosphere.

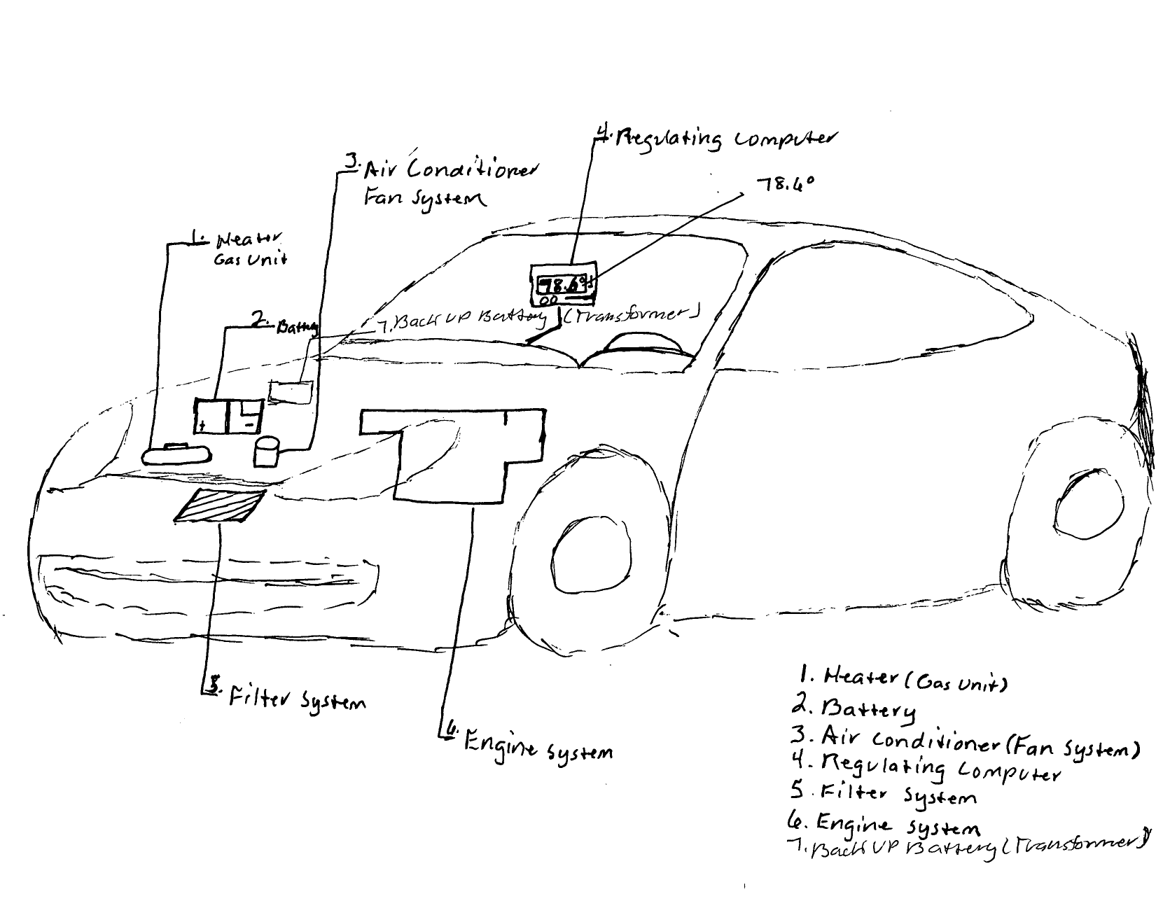

This unique car system allows a person to set the temperature of a car, whether its room temperature or hot or cold, this system will keep the interior of the car at that temperature always. This system will be very helpful in below freezing weather, in which the interior won't be freezing cold, windows won't be frost covered, and the engine would be warmed and ready to go without having to warm up the car. The same goes for extremely hot weather, in which the car interior won't be scorching hot, but it will be nice and cool. This system will have its own independent engine and battery which will also fit under the hood. The system's battery will compliment the car's battery. In which if a car's light is left on when the engine is off, the car's battery will be jump started by the system's battery, so there won't be anymore having to jump start a car with jumper cables.

The system's battery will be extremely powerful allowing it to run for days without having to be recharged by turning on the car engine. This system is pretty much like the thermostat ac/heater system found inside of a house, allowing a house to keep a constant temperature. This system is a luxury device in which it is up to the owner of the vehicle to use this system. The owner will be able to set the system to turn on at a certain time of the day, for example only have the system turn on at 6:00 A.M. So the person doesn't have to keep it on at all times. This system will also have its own gas unit for heating and fan system for cooling and filter to keep nice fresh air in the interior. And it will also have its own computer to regulate the system so the system will know when to be turned on due to temperature change or turn on and off settings set by the owner. I came up with this invention on Nov. 7, 2000.

What I claim as my invention is:

1. The Car Regulating Thermostat comprising:
a. Its own motor for operation without having the automobiles engine running it. Thus preventing gas consumption and pollution into the atmosphere.
b. Its own rechargeable battery to run the motor without running the automobile's battery, making the system completely independent from the automobile's current system.
c. Its own filter system which will ensure clean air into the inside of the automobile.
d. Its own air system or ac which will give the system the capability to cool down the inside of the vehicle during extreme hot weather. It is optional to have its own air system or use that of the automobile's air system.
e. Its own heating unit or heater which will give the system the capability to heat up the inside of the vehicle as well as the engine of the automobile during extreme cold weather without having to turn on the automobile just to heat it up and burn up gas. It is optional to have its own heating unit or use that of the automobile's heating unit.
f. Its own regulating computer system which will be fully customizable in making settings for the system to operate, whether it be set to operate only during weather temperature change or during a set time such as 6:00 A.M. The system will be able to calculate the temperature inside the vehicle as well as outside the vehicle making it fully capable of being an automatic system.
g. Its own transformer battery for back up power, incase the rechargeable battery is low on power. Which the transformer battery will be recharged by the automobile's running engine. With this network of power the patented Trinity System has been established.

2. The patented Trinity System claimed in claim 1 will ensure that the system will always have a power source making this system very reliable. The function of this Trinity System is that the rechargeable battery runs the system and gets recharged back up power from the transformer which the transformer gets its recharged back up power from the automobile's running engine.

3. The motor claimed in claim 1 does not have to be limited to a battery for its power source. Other power sources can be taken into consideration such as fuel cells, solar energy and any other power source current and future.

4. The system will also have an optional remote control device that can be used to activate the system on command or even make settings for the computer to follow. And also with this remote control device, temperature inside and outside of the automobile can be determined according to the Car Regulating Thermostat's regulating computer system. These commands, settings and information will be displayed on a compact screen and can be used anywhere.
